(19) United States
(12) Patent Application Publication
(10) Pub. No.: US 2021/0091912 A1
(43) Pub. Date: Mar. 25, 2021

(54) BANDWIDTH PART MECHANISMS FOR V2X COMMUNICATION

(71) Applicant: MEDIATEK SINGAPORE PTE. LTD., Singapore (SG)

(72) Inventors: Zhixun TANG, Beijing (CN); Tao CHEN, Beijing (CN); Min LEI, Beijing (CN)

(73) Assignee: MEDIATEK SINGAPORE PTE. LTD., Singapore (SG)

(21) Appl. No.: 16/993,780

(22) Filed: Aug. 14, 2020

Related U.S. Application Data
(63) Continuation of application No. PCT/CN2019/100784, filed on Aug. 15, 2019.

(30) Foreign Application Priority Data
Aug. 5, 2020 (CN) 202010776390.7

(51) Int. Cl. H04L 5/00; H04W 76/27; H04W 80/02; H04W 72/04

(52) U.S. Cl. CPC H04L 5/0096; H04L 5/0092; H04L 5/0078; H04W 92/18; H04W 80/02; H04W 72/042; H04W 72/0453; H04W 76/27

(57) ABSTRACT

Aspects of the disclosure provide a method and an apparatus for switching to the next Uu bandwidth part (BWP) from a sidelink BWP (SL BWP) that is switched from an original Uu BWP. For example, the method can include operating, at a user equipment, on an original Uu BWP, switching from the original Uu BWP to an SL BWP, and switching from the SL BWP to the next Uu BWP. In some embodiments, switching from the SL BWP to the next Uu BWP can include switching from the SL BWP to the original Uu BWP followed by switching from the original Uu BWP to the next Uu BWP. In other embodiments, switching from the SL BWP to the next Uu BWP can include switching from the SL BWP to a default Uu BWP followed by switching from the default Uu BWP to the next Uu BWP.

### INCORPORATION BY REFERENCE

This present disclosure claims the priority of PCT/CN2019/100786, titled “CHANNEL STRUCTURE DESIGN FOR V2X COMMUNICATION” filed on Aug. 15, 2019, and Chinese Patent Application No. 202010776390.7 filed on Aug. 5, 2020, which are incorporated herein by reference in their entirety.

### TECHNICAL FIELD

The present disclosure relates to wireless communications and, more particularly, to bandwidth part (BWP) mechanisms for vehicle-to-everything (V2X) communication.

### BACKGROUND

The background description provided herein is for the purpose of generally presenting the context of the disclosure. Work of the presently named inventors, to the extent the work is described in this background section, as well as aspects of the description that may not otherwise qualify as prior art at the time of filing, are neither expressly nor impliedly admitted as prior art against the present disclosure.

New radio (NR) cellular technology is designed to support various and new industrial use cases, such as enhanced mobile broadband (eMBB), ultra-reliable and low latency communication (URLCC), massive machine type communication (mMTC), and vehicle-to-everything (V2X) communication. These use cases require highly challenging quality of service (QoS) metrics, such as peak data rate, latency, reliability, availability, and coverage bandwidth. Inefficient energy consumption leads to poor user experience. NR radio access technology improves battery efficiency and achieves power savings through, for example, bandwidth part (BWP) switching. A user equipment (UE) can open a wider BWP when a large amount of data is scheduled, and switch the wider BWP to a narrower BWP for monitoring control channels to reduce power consumption.

### SUMMARY

Aspects of the disclosure provide a method for switching to the next Uu bandwidth part (BWP) from a sidelink BWP (SL BWP) switched from an original Uu BWP. The method can include operating, at a user equipment (UE), on an original Uu BWP, switching from the original Uu BWP to an SL BWP, and switching from the SL BWP to the next Uu BWP. In some embodiments, switching from the SL BWP to the next Uu BWP can include switching from the SL BWP to the original Uu BWP followed by switching from the original Uu BWP to the next Uu BWP. For example, switching from the original Uu BWP to the next Uu BWP can include switching from the original Uu BWP to a default Uu BWP followed by switching from the default Uu BWP to the next Uu BWP. In other embodiments, switching from the SL BWP to the next Uu BWP can include switching from the SL BWP to a default Uu BWP followed by switching from the default Uu BWP to the next Uu BWP. In various embodiments, switching from the SL BWP to the next Uu BWP can include switching from the SL BWP to a default SL BWP followed by switching from the default SL BWP to the next Uu BWP.

For example, the method can further include receiving a signaling indicating a switch from the SL BWP to the next Uu BWP. For example, the signaling can be a radio resource control (RRC) signaling, a media access control (MAC) control element (CE), or downlink control information (DCI).

In some embodiments, the method can further include setting a sidelink timer (SL timer), and the SL BWP can be switched back to the next Uu BWP after the SL timer expires. In other embodiments, the method can further include setting a Uu timer, and switching from the SL BWP to the next Uu BWP can include switching from the SL BWP to the original Uu BWP after the SL timer expires followed by switching from the original Uu BWP to the next Uu BWP or a default Uu BWP after the Uu timer expires. For example, the Uu timer has a length longer than a length of the SL timer. In some embodiments, the method can further include setting a Uu timer, and switching from the original Uu BWP to the next Uu BWP can include switching from the original Uu BWP to a default Uu BWP after the SL timer expires and switching from the default Uu BWP to the next Uu BWP after the Uu timer expires.

Aspects of the disclosure also provide an apparatus for switching to the next Uu BWP from an SL BWP that is switched from an original Uu BWP. For example, the apparatus can include receiving circuitry and processing circuitry. The receiving circuitry can be configured for receiving wireless signals. The processing circuitry can be configured for operating on an original Uu BWP, switching from the original Uu BWP to the SL BWP, and switching from the SL BWP to the next Uu BWP in response to the wireless signals. In an embodiment, the wireless signals can instruct the processing circuitry to switch from the SL BWP to the original Uu BWP and then switch from the original Uu BWP to the next Uu BWP when the processing circuitry switches from the SL BWP to the next Uu BWP. For example, the wireless signals can further instruct the processing circuitry to switch from the original Uu BWP to a default Uu BWP and then switch from the default Uu BWP to the next Uu BWP when the processing circuitry switches from the original Uu BWP to the next Uu BWP. In other embodiments, the wireless signals can instruct the processing circuitry to switch from the SL BWP to a default Uu BWP and then switch from the default Uu BWP to the next Uu BWP when the processing circuitry switches from the SL BWP to the next Uu BWP. In various embodiments, the wireless signals can instruct the processing circuitry to switch from the SL BWP to a default SL BWP and then switch from the default SL BWP to the next Uu BWP when the processing circuitry switches from the SL BWP to the next Uu BWP.

In some embodiments, the apparatus can further include an SL timer configured to be set to a length, and the processing circuitry can be further configured for switching from the SL BWP to the next Uu BWP after the SL timer expires. In other embodiments, the apparatus can further include a Uu timer configured to be set to a length, and the processing circuitry can be further configured for switching from the SL BWP to the original Uu BWP after the SL timer expires and then switching from the original Uu BWP to the next Uu BWP or a default Uu BWP after the Uu timer expires. In some embodiments, the apparatus can further include a Uu timer configured to be set to a length, and the processing circuitry can be further configured for switching from the original Uu BWP to a default Uu BWP after the SL timer expires, and switching from the default Uu BWP to the next Uu BWP after the Uu timer expires. For example, the Uu timer can have a length longer than a length of the SL timer.

### BRIEF DESCRIPTION OF THE DRAWINGS

Various embodiments of this disclosure that are proposed as examples will be described in detail with reference to the following figures, wherein like numerals reference like elements, and wherein:

FIG. 1 shows an exemplary wireless communication system according to some embodiments of the disclosure;

FIGS. 2-4 show three different exemplary BWP allocation scenarios according to some embodiments of the disclosure;

FIG. 5 shows an exemplary DL/UL BWP switching according to some embodiments of the disclosure;

FIG. 6 is a timing diagram showing an exemplary DCI-based BWP switching process according to some embodiments of the disclosure;

FIGS. 7-11 shows exemplary SL-Uu BWP switching processes according to some embodiments of the disclosure;

FIG. 12 is a flow chart of an exemplary method for switching to the next Uu BWP from an SL BWP that is switched from an original Uu BWP according to some embodiments of the disclosure;

FIG. 13 shows an exemplary flow chart of a step of the method of FIG. 12 according to some embodiments of the disclosure;

FIG. 14 is a functional block diagram of an exemplary apparatus for switching to the next Uu BWP from an SL BWP that is switched from an original Uu BWP according to some embodiments of the disclosure; and

FIG. 15 is a functional block diagram of another exemplary apparatus for switching to the next Uu BWP from an SL BWP that is switched from an original Uu BWP according to some embodiments of the disclosure.

### DETAILED DESCRIPTION OF EMBODIMENTS

A user equipment (UE) can operate on a wide Uu bandwidth part (BWP) when a base station (BS) needs to transmit a great amount of data, or be switched to operate on a narrow Uu BWP to save power. The UE can also be switched between a Uu BWP and a sidelink BWP (SL BWP). An SL BWP cannot be an initial BWP, and has to be switched from a Uu BWP, e.g., an original Uu BWP. According to some embodiments of the disclosure, the SL BWP that is switched from the original Uu BWP can be switched to the next Uu BWP directly. According to other embodiments of the disclosure, the SL BWP that is switched from the original Uu BWP can be switched to a default Uu BWP and may then additionally switched from the default Uu BWP to the next Uu BWP. According to various embodiments of the disclosure, the SL BWP that is switched from the original Uu BWP can be switched back to the original Uu BWP first and then switched from the original Uu BWP to the next Uu BWP. Alternatively, the SL BWP that is switched from the original Uu BWP can be switched back to the original Uu BWP first and then switched from the original Uu BWP to a default Uu BWP, and may then additionally switched from the default Uu BWP to the next Uu BWP. According to some other embodiments of the disclosure, the SL BWP that is switched from the original Uu BWP can be switched to a default SL BWP and may then additionally switched from the default SL BWP to the next Uu BWP.

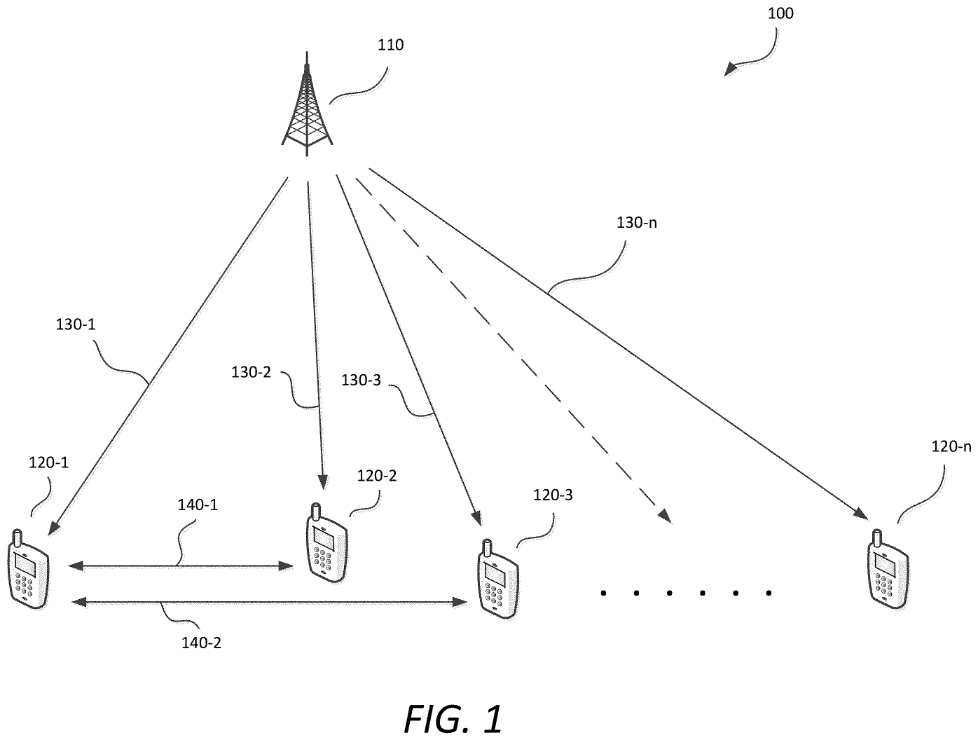

FIG. 1 shows an exemplary wireless communication system 100 according to some embodiments of the disclosure. For example, the wireless communication system 100 can be a long term evolution (LTE) network, an LTE-advanced (LTE-A) network, or a new radio (NR) network. The wireless communication system 100 can include a base station 110 and multiple user equipment (UEs) 120-1 to 120-n. The BS 110 can wirelessly communicate with the UEs 120-1 to 120-n via radio interfaces (referred to as Uu or direct link interfaces, e.g., uplink radio interfaces) 130-1 to 130-n, respectively. The UEs 120-1 to 120-n can also wirelessly communicate with each other via radio interfaces (referred to as PC5 interfaces, e.g., sidelink radio interfaces). For example, the UE 120-1 can communicate with the UEs 120-2 and 120-3 via sidelink radio interfaces 140-1 and 140-2, respectively. In some embodiments, the BS 110 can be a NodeB (NB), an evolved NodeB (eNB), or a next-generation NodeB (gNB). In some other embodiments, the UEs 120 can be any device that is capable of wirelessly communicating with the BS 110 via the uplink radio interfaces 130, as well as communicating with the UEs 120 via the sidelink radio interfaces 140. For example, the UEs 120 can be a vehicle, a computer, a mobile phone, and the like.

LTE is designed under the assumption that all devices (e.g., the UE 120) are capable of the maximum carrier bandwidth of 20 MHz. The same assumption is not reasonable for NR, given the very wide carrier bandwidth supported. Consequently, means for handling different device capabilities in terms of bandwidth support must be included in the NR design. Furthermore, receiving a very wide bandwidth can be expensive in terms of power consumption compared to receiving a narrower bandwidth. It is better that in NR a device can employ a narrower bandwidth to monitor control channel and to receive data transmission of small to medium size, and adapt to a wider bandwidth when a large amount of data is scheduled. NR defines bandwidth parts (BWPs) to handle the above two aspects.

A BWP is a contiguous set of physical resource blocks (PRBs), selected from a contiguous subset of the common resource blocks for a given numerology on a given carrier. The UE 120 can be configured with up to four downlink BWPs (DL BWPs) in the downlink with a single DL BWP being active (i.e., the active DL BWP) at a given time. Also, the UE 120 can be configured with up to four uplink BWPs (UL BWPs) in the uplink with a single UL BWP being active (i.e., the active UL BWP) at a given time. The DL BWPs and the UL BWPs are collectively referred to as Uu BWPs. If the UE 120 is configured with a supplementary uplink, the UE 120 can in addition be configured with up to four supplementary UL BWPs in the supplementary uplink with a single supplementary UL BWP being active at a given time. The four DL/UL BWPs consist of initial, active and UE-specific DL/UL BWPs. The UE 120 is not expected to receive physical downlink shared channel (PDSCH), physical downlink control channel (PDCCH) or channel state information-reference signal (CSI-RS) (except for radio resource management (RRM)) outside the active DL BWP. Similarly, the UE 120 shall not transmit physical uplink shared channel (PUSCH) or physical uplink control channel (PUCCH) outside the active UL BWP.

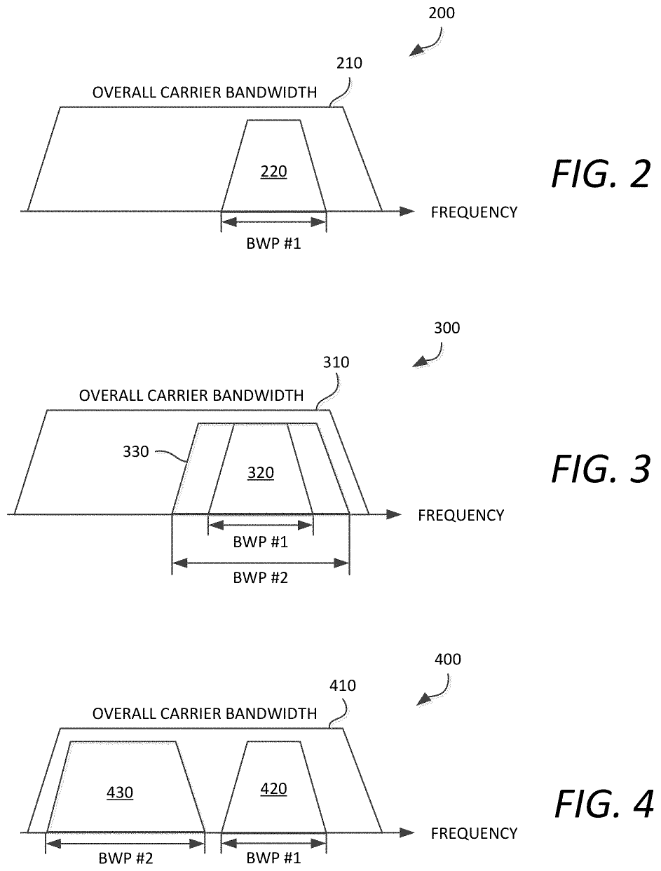

FIGS. 2-4 show three different exemplary BWP allocation scenarios 200, 300, and 400 according to some embodiments of the disclosure. As shown in FIG. 2, the BWP allocation scenario 200 can support reduced UE bandwidth capability (e.g., BWP #1 220) that is especially helpful for UEs with limited RF capability or not capable of full carrier bandwidth (e.g., an overall carrier bandwidth 210). As shown in FIG. 3, the BWP allocation scenario 300 can support reduced UE power consumption for intermittent and bursty traffic profile. For example, the UE 120 can operate on BWP #1 320 in an overall carrier bandwidth 310 for intermittent traffic profile, and be switched to operate on BWP #2 330 for receiving bursty data. In the BWP allocation scenario 300, BWP #1 320 and BWP #2 330 have the same center frequency and subcarrier spacing (SCS) but different bandwidths. As shown in FIG. 4, the BWP allocation scenario 400 can support two non-contiguous BWPs with different numerologies allowing different services multiplexing. In the BWP allocation scenario 400, BWP #1 420 and BWP #2 430 in an overall carrier bandwidth 410 have different center frequencies, SCSs and bandwidths.

Each BWP is defined by at least the following configuration parameters: numerology, including cyclic prefix (CP) length, SCS and symbol duration; frequency location, including an offset between the BWP and a reference point; bandwidth size in terms of physical resource blocks (PRBs); and control resource set (CORESET).

According to the 3^{rd} generation partnership project (3GPP) TS 38.321, BWP selection and switching can be done with the following mechanisms. Radio resource control (RRC)-based adaptation (e.g., using a dedicated RRC signaling) is suitable for semi-static cases since the processing of RRC messages requires extra time, letting the latency reach as long as 10 msec. Media access control (MAC) control element (CE) adaptation is used upon initiation of a random access procedure. Downlink control information (DCI)-based adaptation (e.g., using a PDCCH DCI) is based on PDCCH channel where a specific BWP can be activated by BWP indicator in DCI format 0_1 (UL grant) and DCI format 1_1 (DL scheduling). DCI-based adaptation, though having latency as low as 2 msec, requires additional considerations for error case handling, as the UE 120 may fail to decode the DCI having the BWP activation/deactivation command. To help to recover from such a DCI lost scenario, timer-based implicit fallback to default BWP (e.g., a bwp-inactivityTimer) is designed to mitigate possible DCI errors. After the UE 120 receives the DCI-based BWP switching command, the timer starts to run. If the UE 120 is not explicitly scheduled with a BWP after the timer expires, it will automatically switch its active DL BWP to a default BWP.

There is an initial BWP for the UE 120 during the initial access until the UE 120 is explicitly configured with BWPs during or after RRC connection establishment. For a serving cell of the BS 110, the UE 120 can be provided by defaultDownlink BWP_Id a default DL BWP among the configured DL BWPs. If the UE 120 is not provided a default DL BWP by defaultDownlink BWP_Id, the default DL BWP is the initial DL BWP.

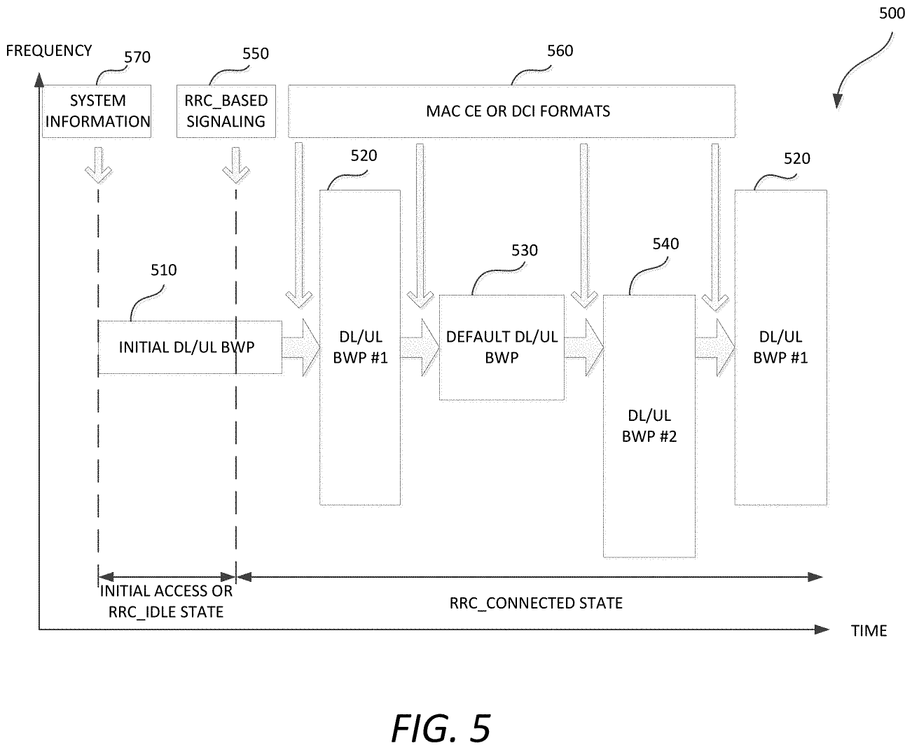

FIG. 5 shows an exemplary DL/UL BWP switching 500 according to some embodiments of the disclosure. As shown, initial DL/UL BWP 510, DL/UL BWP #1 520 and default DL/UL BWP 530 have the same center frequency but different bandwidths, and are different from DL/UL BWP #2 540 in terms of center frequencies and bandwidths. The UE 120 in a radio resource control idle (RRC idle) state can perform a random access procedure based on system information 570, and enter an RRC connected state. Then the UE 120 can be configured initial DL/UL BWP 510, DL/UL BWP #1 520, default DL/UL BWP 530 and DL/UL BWP #2 540 by RRC-based signaling 550 from higher layers that may include a variety of parameters, such as PRB-index-DL-common, initialDownlinkBWP, BWP-DownlinkDedicated, firstActiveDownlinkBWP-Id, locationAndBandwidth and bwp-InactivityTimer, and use initial DL/UL BWP 510 as an active DL/UL BWP to receive and transmit data. In some embodiments, a BWP switching process can be performed by MAC CE or DCI formats 560 to switch initial DL/UL BWP 510 to one of DL/UL BWP #1 520, default DL/UL BWP 530 and DL/UL BWP #2 540 as an active DL/UL BWP. For example, a bandwidth part indicator field in DCI format 1_1, if configured, can indicate the active DL BWP. For another example, a bandwidth part indicator field in DCI format 0_1, if configured, can indicate the active UL BWP. If a bandwidth part indicator field is configured in DCI format 0_1 or DCI format 1_1 560 and indicates an UL BWP or a DL BWP different from the active UL BWP or DL BWP, respectively, the UE 120 shall set the active UL BWP or DL BWP to the UL BWP or DL BWP indicated by the bandwidth part indicator in the DCI format 0_1 or DCI format 1_1, respectively.

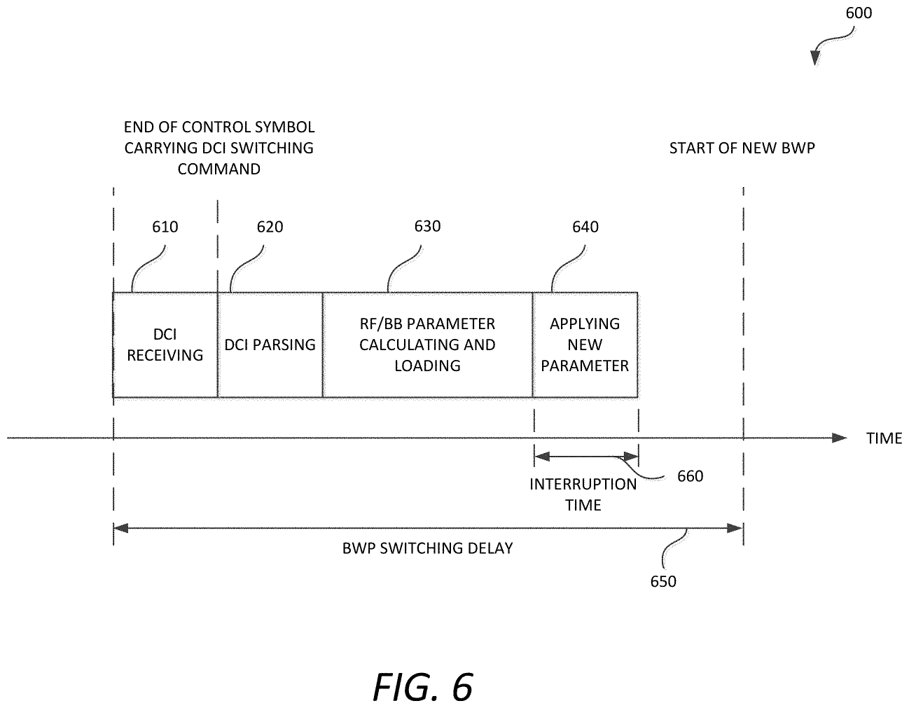

FIG. 6 is a timing diagram showing an exemplary DCI-based BWP switching process 600 according to some embodiments of the disclosure. In a first operation 610, the UE 120 can receive a DCI (e.g., a DCI switching command) from the BS 110. The DCI switching command can include a BWP indicator for BWP switching. In a second operation 620, the UE 120 can detect and decode the DCI switching command. In a third operation 630, the UE 120 can be ready for radio frequency/baseband (RF/BB) parameter calculating and loading. For example, the UE 120 can recalculate RF/BB configuration (e.g., spur estimation, synthesizers reprogramming estimation, and low-IF calculation). In a fourth operation 640, the UE 120 can apply the new parameters obtained in the third operation 630. For example, the UE 120 can tune one or more transceivers to a new center frequency and new bandwidth associated with the BWP indicated by the DCI switching command. Tuning the transceivers (hereinafter referred to as “RF tuning”) may include resetting PLL and reprogramming synthesizers with optimized values for new channel and channel combination due to the BWP switching, which take a great amount of time. Additionally, the UE 120 can tune the BB by changing the SCS associated with the active BWP to the SCS associated with the BWP indicated by the DCI switching command.

A BWP switching delay 650 can at least span from the beginning of the first operation 610 (i.e., upon the reception of the DCI switching command) till the end of the fourth operation 640, at which the applying new parameter is complete. From RANI perspective, the BWP switching delay 650 can be the time duration from the end of last OFDM symbol of the PDCCH carrying the active BWP switching DCI (i.e., the DCI switching command) till the beginning of a slot indicated by KO in the active DL BWP switching DCI or K2 in the active UL BWP switching DCI. The UE 120 cannot monitor data transmission from the BS 110 until the BWP switching delay 650 passes. In some embodiments, applying new parameters may cause interruption of one or more slots to other active serving cells in the same frequency range where the UE 120 is performing the BWP switching process 600. In this regard, an interruption time 660 can be as long as the time used for RF/BB parameter calculating and loading. In some embodiments, the interruption time 660 can be allowed to start only within the BWP switching delay 650.

From RAN4 perspective, RF tuning time can be different for intra-band scenario and inter-band scenarios. For example, for the intra-band scenario, RF tuning time can be up to 20 μsec if the center frequency is the same before and after the BWP switching (e.g., the BWP allocation scenario 300 of FIG. 3), or can be up to 50-200 μsec if the center frequency is different before and after the BWP switching; and for the inter-band scenario, RF tuning time can be up to 900 μsec.

On the serving cell of the BS 110 of the wireless communication system 100, the UE 120 can be further configured an active sidelink BWP (SL BWP) at a given time. The same SL BWP is used for both Tx and Rx. Configuration signaling for SL BWP is separated from Uu BWP configuration signaling. In a licensed carrier, SL BWP is defined separately from Uu BWP (e.g., UL BWP) from the specification perspective. In some embodiments, the UE 120 is not expected to use different numerology in the configured SL BWP and active UL BWP in the same carrier at a given time. If the active UL BWP numerology is different from the SL BWP numerology, the SL BWP is deactivated. From legacy LTE agreement, the SL-Uu switching does not need to happen immediately after the UE 120 receives a DCI command. The SL-Uu switching can be performed at least four slots after the reception of the DCI command. Therefore, the DCI parsing time should not be considered in V2X BWP switching.

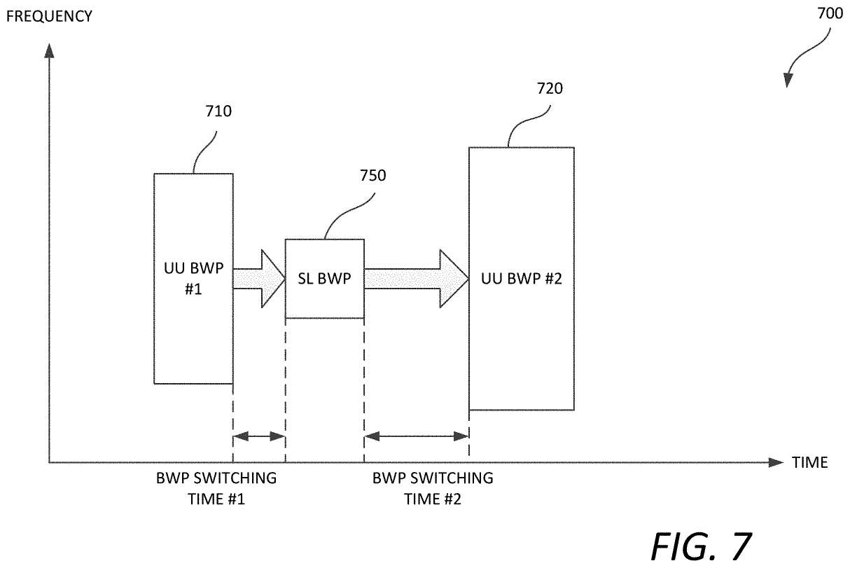

FIG. 7 shows an exemplary SL-Uu BWP switching process 700 according to some embodiments of the disclosure. In the SL-Uu BWP switching process 700, an SL BWP that is switched from an original Uu BWP can be switched to the next Uu BWP directly. For example, the UE 120 can be configured to operate on a Uu BWP #1 710 (i.e., the original Uu BWP) initially, then switched to operate on an SL BWP 750, and finally switched from the SL BWP 750 to a Uu BWP #2 720 (i.e., the next Uu BWP) directly. In a scenario that the UE 120 is provided with an SL memory and a Uu memory, as the SL memory and the Uu memory already have the BWP configurations for the SL BWP 750 and the original Uu BWP #1 710 stored therein, respectively, after the original Uu BWP #1 710 is switched to the SL BWP 750, the UE 120 can store the new BWP configuration for the next Uu BWP #2 720 into the Uu memory and prepare parameters for the RF/BB parameter calculating and loading, and, therefore, longer BWP switching time #2 compared to BWP switching time #1, e.g., three slots, is required for the UE 120 to complete the switching between the SL BWP 750 to the next Uu BWP #2 720. In some embodiments, the original Uu BWP #1 710 can be an uplink (UL) or downlink (DL) BWP, and the next Uu BWP #2 720 can also be an UL or DL BWP. For example, the SL BWP 750 can be switched from an UL BWP and switched to another UL BWP; the SL BWP 750 can be switched from an UL BWP and switched to a DL BWP; the SL BWP 750 can be switched from a DL BWP and switched to another DL BWP; and the SL BWP 750 can be switched from a DL BWP and switched to an UL BWP. Please note that BWP switching time in the invention are illustrated only, and can be designed differently.

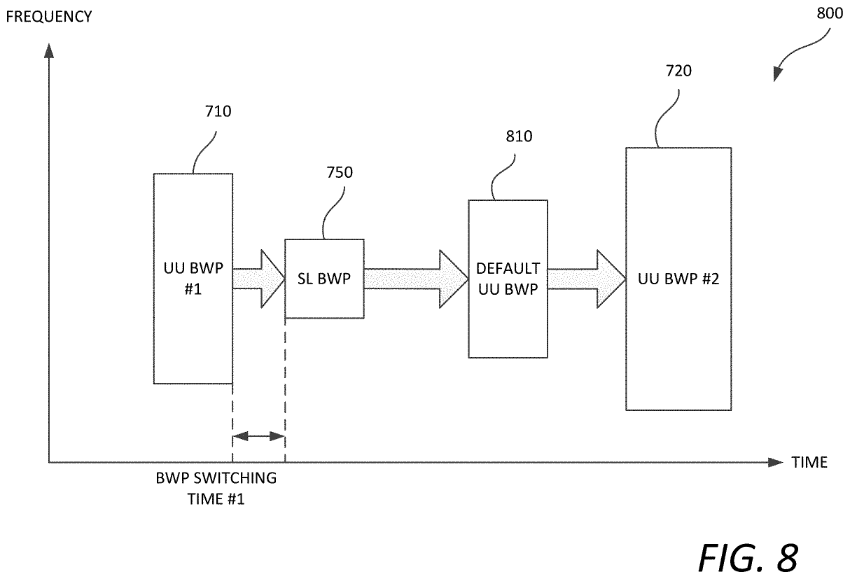

FIG. 8 shows an exemplary SL-Uu BWP switching process 800 according to some embodiments of the disclosure. In the SL-Uu BWP switching process 800, an SL BWP that is switched from an original Uu BWP can be switched to the next Uu BWP indirectly. For example, after operating on the original Uu BWP #1 710 initially and switched to operate on the SL BWP 750, the UE 120 can be switched from the SL BWP 750 to a default Uu BWP 810 first and finally switched from the default Uu BWP 810 to the next Uu BWP #2 720. In some embodiments, the default Uu BWP 810 can be an UL or DL BWP. In another example, after the UE 120 is switched to the default Uu BWP 810, the switching process 800 can be terminated.

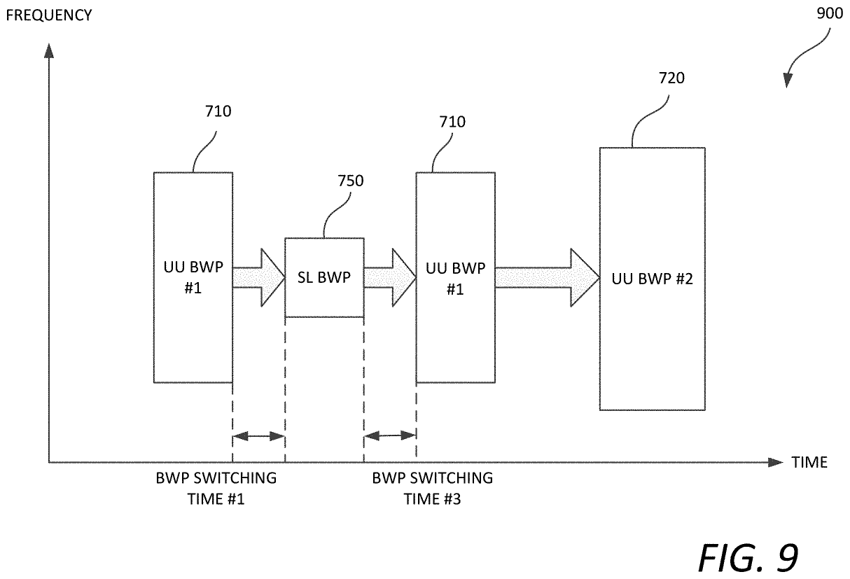

FIG. 9 shows an exemplary SL-Uu BWP switching process 900 according to some embodiments of the disclosure. In the SL-Uu BWP switching process 900, an SL BWP that is switched from an original Uu BWP can also be switched to the next Uu BWP indirectly. For example, after operating on the original Uu BWP #1 710 and switched to the SL BWP 750, the UE 120 can be switched from the SL BWP 750 back to the original Uu BWP #1 710 first and finally switched from the original Uu BWP #1 710 to the next Uu BWP #2 720. As the UE 120 still has the knowledge of the BWP configurations for the original Uu BWP #1 710, which is stored in the Uu memory, BWP switching time #3 required for the UE 120 to switch from the SL BWP 750 to the original Uu BWP #1 710 can be short. For example, BWP switching time #3 can be a couple of symbols, and the UE 120 can complete the switching from the SL BWP 750 to the original Uu BWP #1 710 within one slot. Therefore, the UE 120 can resume data transmission and reception on Uu carriers quickly. In one embodiment, BWP switching time #3 can be equal to BWP switching time #1.

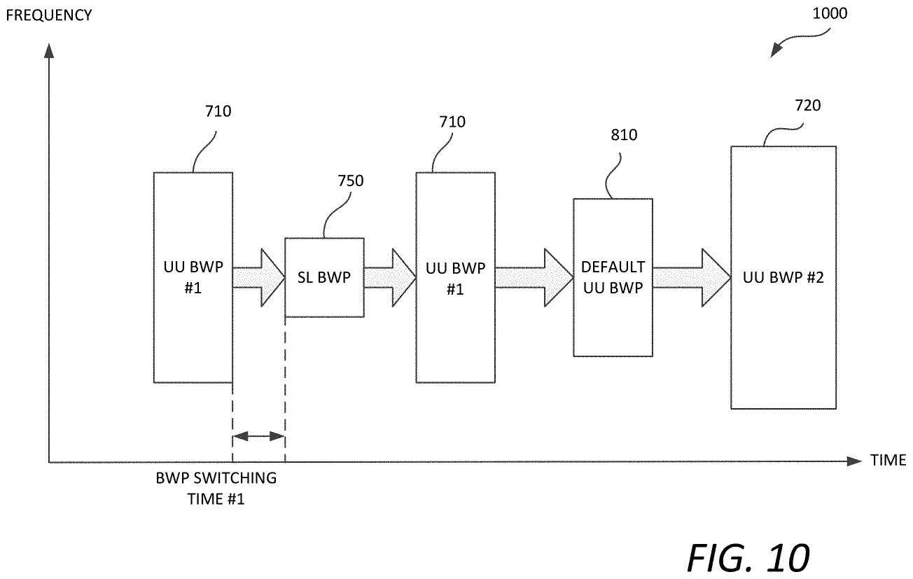

FIG. 10 shows an exemplary SL-Uu BWP switching process 1000 according to some embodiments of the disclosure. In the SL-Uu BWP switching process 1000, an SL BWP that is switched from an original Uu BWP can also be switched to the next Uu BWP indirectly. For example, after operating on the original Uu BWP #1 710 and switched to the SL BWP 750, the UE 120 can be switched from the SL BWP 750 back to the original Uu BWP #1 710 first, then switched from the original Uu BWP #1 710 to the default Uu BWP 810, and finally switched from the default Uu BWP 810 to the next Uu BWP #2 720. In another example, after the UE 120 is switched to the default Uu BWP 810, the switching process 1000 can be terminated.

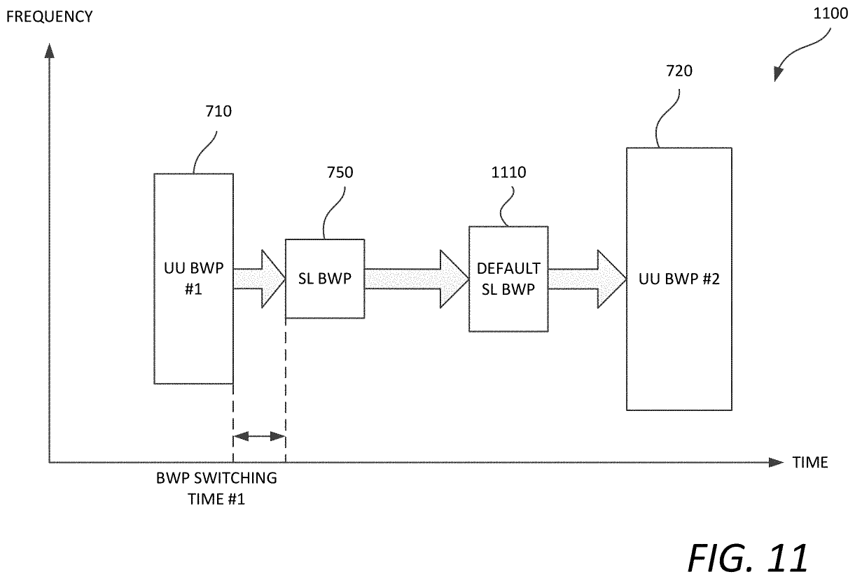

FIG. 11 shows an exemplary SL-Uu BWP switching process 1100 according to some embodiments of the disclosure. In the SL-Uu BWP switching process 1100, an SL BWP that is switched from an original Uu BWP can also be switched to the next Uu BWP indirectly. For example, after operating on the original Uu BWP #1 710 initially and switched to operate on the SL BWP 750, the UE 120 can be switched from the SL BWP 750 to a default SL BWP 1110 first and finally switched from the default SL BWP 1110 to the next Uu BWP #2 720. In another example, after the UE 120 is switched to the default SL BWP 1110, the switching process 1100 can be terminated.

In some embodiments, the original Uu BWP #1 710, the SL BWP 750, the next Uu BWP #2 720 and the default Uu BWP 810 can have the same center frequency. For example, the original Uu BWP #1 710 and the SL BWP 750 can have the same center frequency. In other embodiments, the original Uu BWP #1 710, the SL BWP 750, the next Uu BWP #2 720 and the default Uu BWP 810 can have the same SCS. For example, the original Uu BWP #1 710 and the SL BWP 750 can have the same SCS.

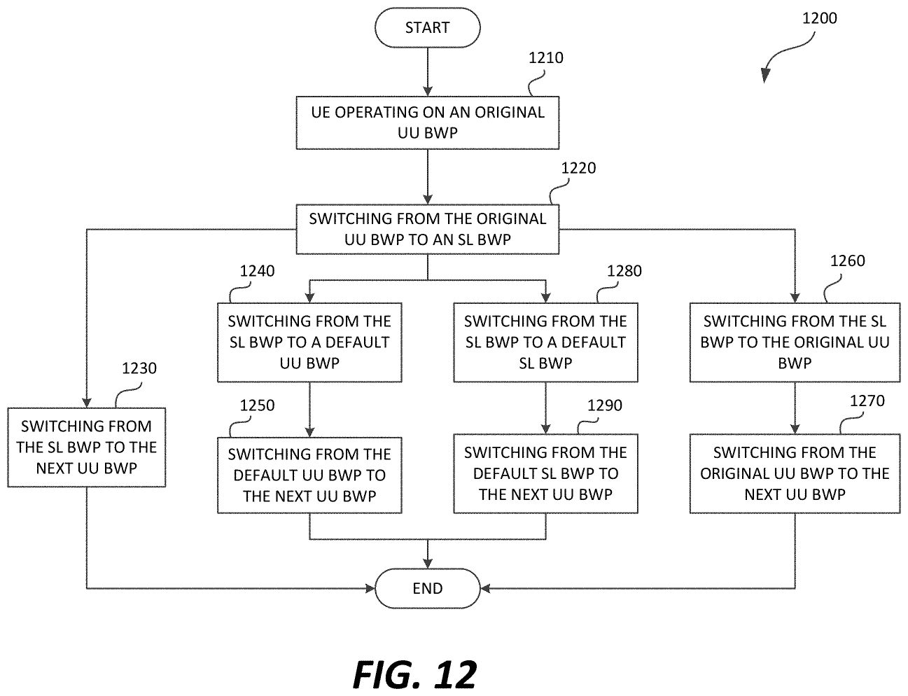

FIG. 12 is a flow chart of an exemplary method 1200 for switching to the next Uu BWP from an SL BWP that is switched from an original Uu BWP according to some embodiments of the disclosure. The method 1200 can be applicable to the wireless communication system 100. In some embodiments, the SL BWP can be switched to the next Uu BWP directly. In other embodiments, the SL BWP can be switched to the next Uu BWP indirectly. In some embodiments, the switching process can be terminated at a default Uu BWP or a default SL BWP. In various embodiments, some of the steps of the method 1200 shown can be performed concurrently, in a different order than shown, can be substituted for by other method step, or can be omitted. Additional method steps can also be performed as desired. Aspects of the method 1200 can be implemented by a wireless device, such as the UE 120 illustrated in and describe with respect to the preceding figures.

At step 1210, the UE 120 can operate on an original Uu BWP. For example, the UE 120 can operate on the Uu BWP #1 710 initially. In some embodiments, the UE 120 can be in-coverage of a serving cell associated with the BS 110 on a vehicle-to-everything (V2X) carrier.

At step 1220, the UE 120 can be switched to operate from the original Uu BWP to an SL BWP. For example, the UE 120 can be switched from the original Uu BWP #1 710 to operate on the SL BWP 750.

At step 1230, the UE 120 can be switched from the SL BWP to the next Uu BWP directly. For example, the UE 120 can be switched from the SL BWP 750 to the next Uu BWP #2 720 directly, as shown in FIG. 7. In some embodiments, the UE 120 can further receive from the BS 110 a signaling indicating a switch from the SL BWP 750 to the next Uu BWP #2 720. For example, the signaling can be an RRC signal, a MAC CE or DCI. In other embodiments, the signaling may be denoted by a sidelink timer (SL timer), or in other words, the SL timer can be set, and the SL BWP 750 can be switched to the next Uu BWP #2 720 after the SL timer expires. In various embodiments, the next Uu BWP can be the original Uu BWP or the default Uu BWP, and the original Uu BWP, the default Uu BWP and the SL BWP can be switched to each other periodically.

At steps 1240 and 1250, the UE 120 can be switched from the SL BWP to the next Uu BWP indirectly. For example, the UE 120 can be switched from the SL BWP 750 to the next Uu BWP #2 720 indirectly. In some embodiments, the UE 120 can be switched from the SL BWP 750 to the default Uu BWP 810 at step 1240 first and then switched from the default Uu BWP 810 to the next Uu BWP #2 720 at step 1250, as shown in FIG. 8. In some embodiments, the UE 120 can further receive from the BS 110 a signaling indicating a switch from the SL BWP 750 to the next Uu BWP #2 720. For example, the signaling can indicate switching from the SL BWP 750 to the default Uu BWP 810 first and then switching from the default Uu BWP 810 to the next Uu BWP #2 720. In other embodiments, the signaling may be denoted by an SL timer and a Uu timer, or in other words, the SL timer and the Uu timer can be set, the SL BWP 750 can be switched to the default Uu BWP 810 after the SL timer expires, and the default Uu BWP 810 can be switched to the next Uu BWP #2 720 after the Uu timer expires. For example, the Uu timer can have a length longer than a length of the SL timer.

At steps 1260 and 1270, the UE 120 can also be switched from the SL BWP to the next Uu BWP indirectly. For example, the UE 120 can be switched from the SL BWP 750 to the next Uu BWP #2 720 indirectly. In some embodiments, the UE 120 can be switched from the SL BWP 750 to the original Uu BWP #1 710 at step 1260 first and then switched from the original Uu BWP #1 710 to the next Uu BWP #2 720 at step 1270, as shown in FIG. 9. In some embodiments, the UE 120 can further receive from the BS 110 a signaling indicating a switch from the SL BWP 750 to the next Uu BWP #2 720. For example, the signaling can indicate switching from the SL BWP 750 to the original Uu BWP #1 710 first and then switching from the original Uu BWP #1 710 to the next Uu BWP #2 720. In other embodiments, the signaling may be denoted by an SL timer and a Uu timer, or in other words, the SL timer and the Uu timer can be set, the SL BWP 750 can be switched to the original Uu BWP #1 710 after the SL timer expires, and the original Uu BWP #1 710 can be switched to the next Uu BWP #2 720 after the Uu timer expires. For example, the Uu timer can have a length longer than a length of the SL timer.

At steps 1280 and 1290, the UE 120 can also be switched from the SL BWP to the next Uu BWP indirectly. For example, the UE 120 can be switched from the SL BWP 750 to the next Uu BWP #2 720 indirectly. In some embodiments, the UE 120 can be switched from the SL BWP 750 to the default SL BWP 1110 at step 1280 first and then switched from the default SL BWP 1110 to the next Uu BWP #2 720 at step 1290, as shown in FIG. 11. In some embodiments, the UE 120 can further receive from the BS 110 a signaling indicating a switch from the SL BWP 750 to the next Uu BWP #2 720. For example, the signaling can indicate switching from the SL BWP 750 to the default SL BWP 1110 first and then switching from the default SL BWP 1110 to the next Uu BWP #2 720. In other embodiments, the signaling may be denoted by a timer.

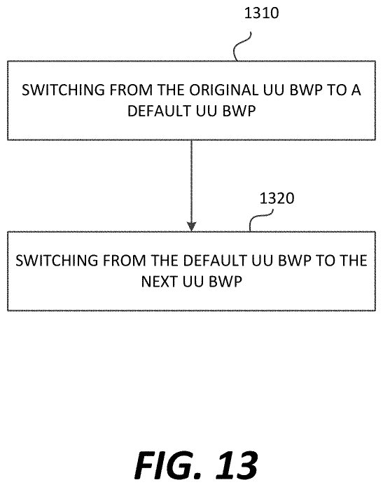

FIG. 13 shows an exemplary flow chart of step 1270 of the method 1200 according to some embodiments of the disclosure. In some embodiments, step 1270 can include steps 1310 and 1320. For example, the UE 120 can be switched from the original Uu BWP #1 710 to the default Uu BWP 810 at step 1310 and switched from the default Uu BWP 810 to the next Uu BWP #2 720 at step 1320, as shown in FIG. 10. In other embodiments, the UE 120 can further receive from the BS 110 a signaling indicating a switch from the SL BWP 750 to the next Uu BWP #2 720. For example, the signaling can indicate switching from the SL BWP 750 to the original Uu BWP #1 710 first, then switching from the original Uu BWP #1 710 to the default Uu BWP 810, and finally switching from the default Uu BWP 810 to the next Uu BWP #2 720. In other embodiments, the signaling can be denoted by an SL timer and a Uu timer, or in other words, the SL timer and the Uu timer can be set, the SL BWP 750 can be switched to the original Uu BWP #1 710 after the SL timer expires, and the original Uu BWP #1 710 can be switched to the default Uu BWP 810 after the Uu timer expires. For example, the Uu timer can have a length longer than a length of the SL timer. In other embodiments, step 1320 can be omitted.

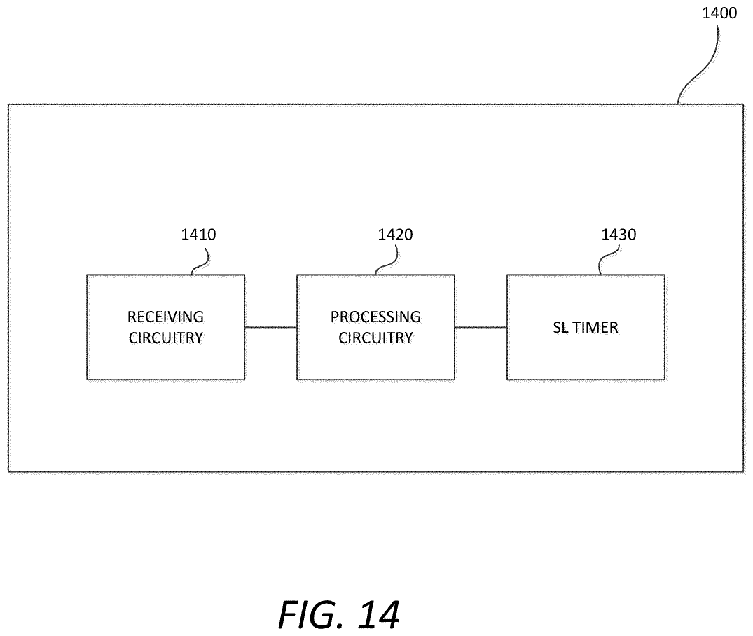

FIG. 14 is a functional block diagram of an exemplary apparatus 1400 for switching to the next Uu BWP from an SL BWP that is switched from an original Uu BWP according to some embodiments of the disclosure. The apparatus 1400 can be configured to perform various functions in accordance with one or more embodiments or examples described herein. Thus, the apparatus 1400 can provide means for implementation of techniques, processes, functions, components, systems described herein. For example, the apparatus 1400 can be used to implement functions of the UE 120 in various embodiments and examples described herein. The apparatus 1400 can be a general purpose computer in some embodiments, and can be a device including specially designed circuits to implement various functions, components, or processes described herein in other embodiments. In some embodiments, the apparatus 1400 can operate on a Uu or SL BWP. The apparatus 1400 can include receiving circuitry 1410, processing circuitry 1420 and an SL timer 1430. In some embodiment, the SL timer 1430 can be omitted.

In some embodiments, the receiving circuitry 1410 can be configured to receive wireless signals. The processing circuitry 1420 can be configured for operating on an original Uu BWP, switching from the original Uu BWP to an SL BWP, and switching from the SL BWP to the next Uu BWP. For example, the next Uu BWP is the original Uu BWP, and the processing circuitry 1420 can be configured for switching the original Uu BWP and the SL BWP to each other periodically. In some embodiments, the receiving circuitry 1410 can be configured for receiving wireless signals, e.g., a signaling. For example, the signaling can be an RRC signaling, a MAC CE, or DCI. In an embodiment, the signaling can instruct the processing circuitry 1420 to switch from the SL BWP to the original Uu BWP first and then switch from the original Uu BWP to the next Uu BWP when switching from the SL BWP to the next Uu BWP. For example, the signaling can further instruct the processing circuitry 1420 to switch from the original Uu BWP to a default Uu BWP (and switch from the default Uu BWP to the next Uu BWP) when switching from the original Uu BWP to the next Uu BWP. In another embodiment, the signaling can instruct the processing circuitry 1420 to switch from the SL BWP to a default Uu BWP (and then switch from the default Uu BWP to the next Uu BWP) when switching from the SL BWP to the next Uu BWP. In yet another embodiment, the signaling can instruct the processing circuitry 1420 to switch from the SL BWP to a default SL BWP first and then switch from the default SL BWP to the next Uu BWP when switching from the SL BWP to the next Uu BWP. In some embodiments, the signaling can be denoted by the SL timer 1430, or in other words, the SL timer 1430 can be set, and the processing circuitry 1420 can be configured for switching from the SL BWP to the next Uu BWP after the SL timer 1430 expires. In other embodiments, the signaling can be denoted by the SL timer 1430, or in other words, the SL timer 1430 can be set, and the processing circuitry 1420 can be configured for switching from the SL BWP to the default Uu BWP after the SL timer 1430 expires. In various embodiments, the signaling can be denoted by the SL timer 1430, or in other words, the SL timer 1430 can be set, and the processing circuitry 1420 can be configured for switching from the SL BWP to the original Uu BWP after the SL timer 1430 expires. In still other embodiments, the signaling can be denoted by the SL timer 1430, or in other words, the SL timer 1430 can be set, and the processing circuitry 1420 can be configured for switching from the SL BWP to the default SL BWP after the SL timer 1430 expires.

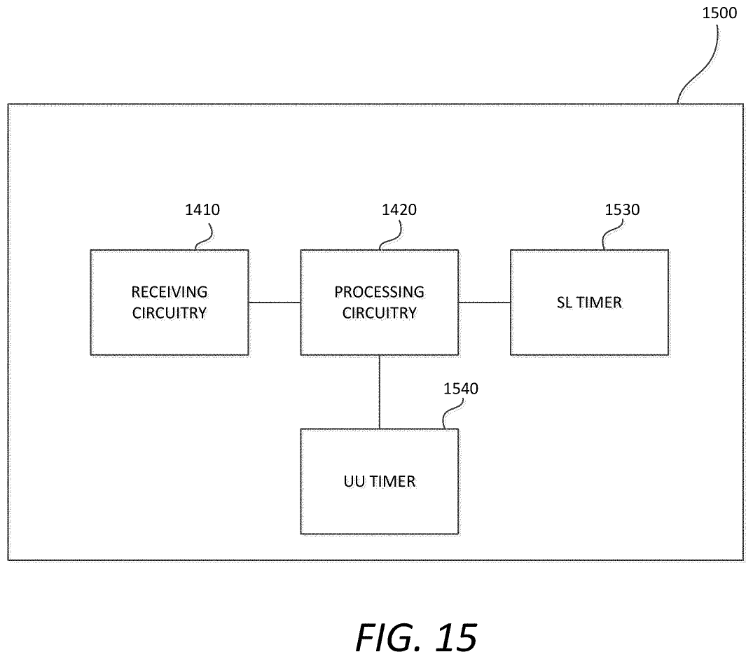

FIG. 15 is a functional block diagram of another exemplary apparatus 1500 for switching to the next Uu BWP from an SL BWP that is switched from an original Uu BWP according to some embodiments of the disclosure. For example, the apparatus 1500 can include the receiving circuitry 1410, the processing circuitry 1420, an SL timer 1530 and a Uu timer 1540. In some embodiments, the receiving circuitry 1410 can be configured for receiving wireless signals, e.g., a signaling indicating a switch from the SL BWP to the next Uu BWP. In an embodiment, the signaling, or another signaling received by the receiving circuitry 1410, can be denoted by the SL timer 1530, or in other words, the SL timer 1530 can be set to a length. In another embodiment, the signaling, or another signaling received by the receiving circuitry 1410, can be denoted by the Uu timer 1540, or in other words, the Uu timer 1540 can be set to a length. In yet another embodiment, the processing circuitry 1420 can be configured for switching from the SL BWP to the original Uu BWP after the SL timer 1530 expires and then switching from the original Uu BWP to the next Uu BWP after the Uu timer 1540 expires. For example, the Uu timer 1540 can have a length longer than a length of the SL timer 1530. In still another embodiment, the processing circuitry 1420 can be configured for switching from the SL BWP to a default Uu BWP after the SL timer 1530 expires and then switching from the default Uu BWP to the next Uu BWP after the Uu timer 1540 expires. In still another embodiment, the processing circuitry 1420 can be configured for switching from the SL BWP to an original Uu BWP after the SL timer 1530 expires and then switching from the original Uu BWP to the default Uu BWP after the Uu timer 1540 expires.

In various embodiments according to the disclosure, the receiving circuitry 1410 and the processing circuitry 1420 can include circuitry configured to perform the functions and processes described herein in combination with software or without software. In various examples, the processing circuitry can be a digital signal processor (DSP), an application specific integrated circuit (ASIC), programmable logic devices (PLDs), field programmable gate arrays (FPGAs), digitally enhanced circuits, or comparable device or a combination thereof. In some other embodiments according to the disclosure, the processing circuitry 1420 can be a central processing unit (CPU) configured to execute program instructions to perform various functions and processes described herein.

The apparatuses 1400 and 1500 can optionally include other components, such as input and output devices, additional or signal processing circuitry, and the like. Accordingly, the apparatuses 1400 and 1500 may be capable of performing other additional functions, such as executing application programs, and processing alternative communication protocols.

The processes and functions described herein can be implemented as a computer program which, when executed by one or more processors, can cause the one or more processors to perform the respective processes and functions. The computer program may be stored or distributed on a suitable medium, such as an optical storage medium or a solid-state medium supplied together with, or as part of, other hardware. The computer program may also be distributed in other forms, such as via the Internet or other wired or wireless telecommunication systems. For example, the computer program can be obtained and loaded into an apparatus, including obtaining the computer program through physical medium or distributed system, including, for example, from a server connected to the Internet.

The computer program may be accessible from a computer-readable medium providing program instructions for use by or in connection with a computer or any instruction execution system. The computer readable medium may include any apparatus that stores, communicates, propagates, or transports the computer program for use by or in connection with an instruction execution system, apparatus, or device. The computer-readable medium can be magnetic, optical, electronic, electromagnetic, infrared, or semiconductor system (or apparatus or device) or a propagation medium. The computer-readable medium may include a computer-readable non-transitory storage medium such as a semiconductor or solid state memory, magnetic tape, a removable computer diskette, a random access memory (RAM), a read-only memory (ROM), a magnetic disk and an optical disk, and the like. The computer-readable non-transitory storage medium can include all types of computer readable medium, including magnetic storage medium, optical storage medium, flash medium, and solid state storage medium.

While aspects of the present disclosure have been described in conjunction with the specific embodiments thereof that are proposed as examples, alternatives, modifications, and variations to the examples may be made. Accordingly, embodiments as set forth herein are intended to be illustrative and not limiting. There are changes that may be made without departing from the scope of the claims set forth below.

What is claimed is:

1. A method, comprising:
operating, at a user equipment (UE), on an original Uu bandwidth part (BWP);
switching from the original Uu BWP to a sidelink BWP (SL BWP); and
switching from the SL BWP to a next Uu BWP.

2. The method of claim 1, wherein switching from the SL BWP to a next Uu BWP includes switching from the SL BWP to the original Uu BWP followed by switching from the original Uu BWP to the next Uu BWP.

3. The method of claim 2, wherein switching from the original Uu BWP to the next Uu BWP includes switching from the original Uu BWP to a default Uu BWP followed by switching from the default Uu BWP to the next Uu BWP.

4. The method of claim 1, wherein switching from the SL BWP to a next Uu BWP includes switching from the SL BWP to a default Uu BWP followed by switching from the default Uu BWP to the next Uu BWP.

5. The method of claim 1, wherein switching from the SL BWP to a next Uu BWP includes switching from the SL BWP to a default SL BWP followed by switching from the default SL BWP to the next Uu BWP.

6. The method of claim 1, prior to switching from the SL BWP to a next Uu BWP, further comprising:
receiving a signaling indicating a switch from the SL BWP to the next Uu BWP.

7. The method of claim 6, wherein the signaling is a radio resource control (RRC) signaling, a media access control (MAC) control element (CE), or downlink control information (DCI).

8. The method of claim 1, further comprising:
setting a sidelink timer (SL timer),
wherein the SL BWP is switched to the next Uu BWP after the SL timer expires.

9. The method of claim 8, further comprising:
setting a Uu timer,
wherein switching from the SL BWP to a next Uu BWP includes switching from the SL BWP to the original Uu BWP after the SL timer expires followed by switching from the original Uu BWP to the next Uu BWP or a default Uu BWP after the Uu timer expires.

10. The method of claim 9, wherein the Uu timer has a length longer than a length of the SL timer.

11. The method of claim 8, further comprising:
setting a Uu timer,
wherein switching from the original Uu BWP to the next Uu BWP includes switching from the original Uu BWP to a default Uu BWP after the SL timer expires followed by switching from the default Uu BWP to the next Uu BWP after the Uu timer expires.

12. An apparatus, comprising:
receiving circuitry configured for receiving wireless signals; and
processing circuitry configured for operating on an original Uu BWP, switching from the original Uu BWP to the SL BWP, and switching from the SL BWP to the next Uu BWP in response to the wireless signals.

13. The apparatus of claim 12, wherein the wireless signals instruct the processing circuitry to switch from the SL BWP to the original Uu BWP and then switch from the original Uu BWP to the next Uu BWP when switching from the SL BWP to the next Uu BWP.

14. The apparatus of claim 13, wherein the wireless signals further instruct the processing circuitry to switch from the original Uu BWP to a default Uu BWP and then switch from the default Uu BWP to the next Uu BWP when switching from the original Uu BWP to the next Uu BWP.

15. The apparatus of claim 12, wherein the wireless signals instruct the processing circuitry to switch from the SL BWP to a default Uu BWP and then switch from the default Uu BWP to the next Uu BWP when switching from the SL BWP to the next Uu BWP.

16. The apparatus of claim 12, wherein the signaling instructs the processing circuitry to switch from the SL BWP to a default SL BWP and then switch from the default SL BWP to the next Uu BWP when switching from the SL BWP to the next Uu BWP.

17. The apparatus of claim 12, further comprising:
an SL timer configured to be set to a length,
wherein the processing circuitry is further configured for switching from the SL BWP to the next Uu BWP after the SL timer expires.

18. The apparatus of claim 17, further comprising:
a Uu timer configured to be set to a length,
wherein the processing circuitry is further configured for switching from the SL BWP to the original Uu BWP after the SL timer expires and then switching from the original Uu BWP to the next Uu BWP or a default Uu BWP after the Uu timer expires.

19. The apparatus of claim 18, wherein the Uu timer has a length longer than a length of the SL timer.

20. The apparatus of claim 17, further comprising:
a Uu timer configured to be set to a length,
wherein the processing circuitry is further configured for switching from the original Uu BWP to a default Uu BWP after the SL timer expires and then switching from the default Uu BWP to the next Uu BWP after the Uu timer expires.
